(19) United States
(12) Patent Application Publication
(10) Pub. No.: US 2005/0151001 A1
(43) Pub. Date: Jul. 14, 2005

(54) Compound helicopter

(76) Inventor: Arthur W. Loper, Fairfield, CT (US)

Correspondence Address: LITMAN LAW OFFICES, LTD, PO BOX 15035, CRYSTAL CITY STATION, ARLINGTON, VA, 22215, US

(21) Appl. No.: 10/871,028

(22) Filed: Jun. 21, 2004

Related U.S. Application Data
(60) Provisional application No. 60/484,049, filed on Jul. 2, 2003.

(51) Int. Cl. B64C 27/22

(52) U.S. Cl. 244/6

(57) ABSTRACT

The compound helicopter is a hybrid combination of a helicopter and a fixed wing aircraft. A conventional helicopter is modified with a nose-mounted tractor propeller to provide thrust for forward flight. Wings are added to provide lift during forward flight. With the propeller providing thrust and the wings lift during forward flight, the helicopter rotor blades are unloaded during cruising flight to allow increased forward speed by avoiding limitations of conventional helicopters, including retreating rotor blade stall and maximum rotor blade tip speeds. A single powerplant drives both the main rotor and the nose-mounted propeller. The compound helicopter employs high aspect ratio wings with large flaps that may be extended to reduce vertical drag during vertical flight and hovering operations.

### CROSS-REFERENCE TO RELATED APPLICATION

This application claims the benefit of U.S. Provisional Patent Application Ser. No. 60/484,049, filed Jul. 2, 2003.

### BACKGROUND OF THE INVENTION

1. Field of the Invention

The present invention relates to vertical take-off and landing aircraft. More specifically, the invention is a compound helicopter having a rotor providing thrust and lift for vertical takeoff, landing, and hovering operations, and a nose-mounted propeller and wings for thrust and lift during forward cruising flight.

2. Description of the Related Art

Helicopters provide a valuable and convenient mode of air transportation. Because of their ability to take off vertically from, and descend vertically into, a small area, they can be operated to and from places that conventional aircraft cannot. As city and suburban populations become denser, and land for airports becomes scarce, the ability of a helicopter to operate from rooftops or small heliports within population centers increases their value.

Despite the advantages of vertical take off and landing capability, conventional helicopters do not perform efficiently in horizontal, cruising flight. The forward velocity of a helicopter is fundamentally limited by various phenomena, including retreating blade stall, a phenomenon in which the airspeed over a retreating rotor blade is decreased as the helicopter's forward speed increases. The tendency for a retreating blade to stall in forward flight is a major factor in limiting the forward speed of all conventional helicopters.

Attempts have been made to combine the vertical takeoff and landing convenience of helicopters with the speed and efficiency in forward flight of conventional winged aircraft. Tilt-rotor aircraft employ wing-mounted rotors that can be tilted from a horizontal plane, where they provide maximum lift for vertical or hovering flight, to a vertical plane where they provide thrust for forward flight. Compound helicopters use a conventional helicopter rotor, but add wings and a separate source of forward thrust for level cruising flight. Various configurations of compound helicopters have been attempted, but none have achieved great success.

U.S. Pat. No. 3,105,659, issued on Oct. 1, 1963 to R. Stutz, discloses a compound helicopter that employs two engine-driven propellers in a conventional twin-engine aircraft configuration, with the engines wing-mounted. The wing-mounted engines drive the helicopter rotor through a shaft coupling. A conventional tail rotor is provided to counteract the torque of the main rotor blades. Because, in this configuration, the propellers are located beneath the main rotor blades, the propellers must operate in the turbulent downwash from the rotors. The mechanical stresses induced on the propellers by the turbulent air prevent the propellers from being operated to produce their maximum thrust. Additionally, the requirement to couple the separately mounted engines to drive the main rotor adds weight to the aircraft. Thus, a compound helicopter of this configuration cannot achieve optimum performance.

U.S. Pat. No. 2,665,859, issued on Jan. 12, 1954 to P. Papadakos, discloses another example of a compound helicopter that derives forward thrust from twin propellers in a conventional twin-engine configuration.

U.S. Pat. No. 3,155,341, issued on Nov. 3, 1964 to P. Girard, discloses a compound helicopter that derives forward thrust from a rear-mounted, pusher-type propeller. In addition to providing thrust, the rear-mounted propeller is pivotable to provide a counter-rotational force against the torque of the main rotor, replacing a conventional helicopter tail-rotor. This illustrates one of the difficulties inherent to the use of a rear-mounted propeller. Typically, a tail rotor is used in a helicopter to counteract the torque of the main rotor. When a compound helicopter employs a rear-mounted, pushing-type propeller, it becomes difficult to locate a conventional tail rotor. A more complex scheme, such as the pivotable rear-mounted propeller of the Girard compound helicopter, must be employed, often at the expense of maximized performance.

U.S. Pat. No. 4,730,795, issued on Mar. 15, 1988 to C. David, illustrates another compound helicopter using a rear-mounted, pusher-type propeller for forward thrust. The David compound helicopter uses, in one embodiment, a pivoted rear-mounted, pusher-type propeller, or, in another embodiment, counter-rotating main rotors, in order to counteract the rotor blade torque.

U.S. Pat. No. 4,928,907, issued on May 29, 1990 to D. Zuck, discloses yet another example of a compound helicopter using a rear-mounted, pusher-type propeller for forward thrust. In the Zuck compound helicopter, the tail rotor is replaced by aileron forces provided by pivotal wings and by a movable horizontal airfoil located on the tail cone or tail boom. U.S. Pat. No. 2,959,373, issued on Nov. 8, 1960, also to D. Zuck, discloses an earlier version of the compound helicopter using a rear-mounted, pusher-type propeller for forward thrust, and using a pivoting rear-mounted propeller to fill the role of the tail rotor.

Additionally, as with the twin wing mounted propellers, the propeller in a rear-mounted pusher configuration is in an area of turbulent airflow caused by the rotor downwash, as well as by the airframe itself. The propeller cannot be operated to its maximum ability in this environment. An additional limitation of the rear-mounted propeller configuration is in the size of propeller that may be used. A restriction of the propeller size translates to a restriction on the thrust that can be produced. Because helicopters typically operate in a somewhat tail-down pitch during takeoff, landing, and hovering operations, there is a risk of the rear-mounted propeller striking the ground or other obstructions. This risk is increased as the size of the propeller is increased. Ordinarily, a helicopter's tail rotor is relatively small because it is not required to produce a large amount of thrust. However, when a propeller is relied on for forward thrust to propel the aircraft in cruising flight, it is desirable to use a larger propeller to achieve greater thrust.

None of the above inventions and patents, taken either singly or in combination, is seen to describe the instant invention as claimed. Thus, a compound helicopter solving the aforementioned problems is desired.

### SUMMARY OF THE INVENTION

The compound helicopter is a hybrid combination of a helicopter and a fixed wing aircraft. A conventional helicopter is modified with a nose-mounted tractor propeller to provide thrust for forward flight. Wings are added to provide lift during forward flight. With the propeller providing thrust and the wings providing lift during forward flight, the helicopter rotor blades are unloaded in order to allow increased forward speed by avoiding the limitations of conventional helicopters, including retreating rotor blade stall and maximum rotor blade tip speeds.

The compound helicopter of the present invention is directed generally to a ten to fourteen seat aircraft in the 12,000-16,000 pound weight category, combining the hover performance of a helicopter with the speed of a fixed wing aircraft. Such an aircraft is suitable for a variety of missions, including a multitude of military and civil applications. The compound helicopter is also suitable to other applications, such as drone aircraft. The compound helicopter offers relative simplicity and a high degree of flight safety. It has the ability to perform touchdown autorotations, as well as to glide to a landing as a fixed wing aircraft. The safety benefit of these lost-power landing modes cannot be overstated.

The propeller is mounted at the nose of the aircraft, where the propeller operates in clean air, free of the turbulence from the rotors. In the clean air environment, the propeller may be operated at a higher degree of efficiency, producing greater thrust than a propeller mounted elsewhere. The propeller is located slightly forward of the main rotor blade tips to prevent contact under high rotor blade flap angles.

The nose-mounted propeller and the main rotor may be driven by the same, or by separate, power sources. In a twin engine configuration, twin turboshaft engines are coupled to provide power for both the main rotor and the propeller. A transmission combines output from both engines to provide a single, redundant, powerplant for both the rotor and the propeller.

The transmission drives two shafts. A first shaft drives the rotor, while a second shaft drives the propeller. Both the rotor drive train and the propeller drive train each include a clutch so that the rotor and the propeller may be independently engaged with and disengaged from the engines. It is thus possible that, during takeoff and landing procedures, the propeller may be disengaged entirely, eliminating a hazard to personnel near the aircraft. Electronic control systems manage the propeller pitch and speed, and collective and cyclic pitch, and speed, of the main rotor in conjunction with a full authority digital engine controller (FADEC) for optimal operation during helicopter and airplane flight modes, and during transition between the modes.

The wings are optimized for high altitude cruising, and have a relatively high aspect ratio for a reduction of induced drag during high speed cruise. The high aspect ratio wings, because they are relatively narrow, present a reduced flat plate area, decreasing vertical drag during vertical or hovering operations. Additionally, the wings feature rather wide flaps that can be deployed during hovering and vertical flight operations to further reduce the flat plate area of the wings. A wing with a 35.3% chord single-slotted flap, deflected reduces vertical drag 40-50% compared to a bare wing. A more complex wing, with a leading edge flap and 30% chord plain flap of an “umbrella” design, reduces drag 70-75% as compared to a bare wing, but at the expense of the complexity of the mechanism required to operate the flaps.

Accordingly, it is a principal object of the invention to provide a compound helicopter with a nose-mounted propeller.

It is another object of the invention to provide a compound helicopter with a nose-mounted propeller for increased forward thrust during cruising flight.

It is a further object of the invention to provide a compound helicopter with a nose-mounted propeller having the propeller located in a clean-air area for improved performance.

Still another object of the invention is to provide a compound helicopter with a high aspect ratio wing to reduce the flat plate area beneath the main rotor.

Yet another object of the invention is to provide a compound helicopter with a high aspect ratio wing with flaps designed to further reduce the flat plate area beneath the main rotor.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a compound helicopter according to the present invention.

FIG. 2 is a top view of a compound helicopter according to the present invention.

FIG. 3 is a front view of a compound helicopter according to the present invention.

FIG. 4 is a side view of a compound helicopter according to the present invention.

FIG. 5 is a diagrammatic cut-away side view of a compound helicopter according to the present invention, showing the rotor and propeller drive trains of an embodiment incorporating a twin engine powerplant.

FIG. 6 is a schematic diagram of the rotor and propeller driving mechanism of the compound helicopter shown in FIG. 5.

FIG. 7 is a schematic of the engines, gear box, and rotor driving mechanism of the compound helicopter shown in FIG. 5.

FIG. 8 is a perspective view of a twin-engine powerplant according to a preferred embodiment of the compound helicopter shown in FIG. 5.

FIG. 9 is a top view of the twin-engine powerplant shown in FIG. 8.

FIG. 10 is section view of the transmission assembly for the twin-engine powerplant shown in FIG. 8.

FIG. 11 is a diagrammatic cut-away side view of a compound helicopter according to the present invention, showing the rotor and propeller drive trains of an alternate embodiment wherein the powerplant is located in the nose of the compound helicopter.

FIG. 12 is a diagrammatic cut-away side view of an alternate embodiment of a compound helicopter according to the present invention, configured for use as an unmanned aerial vehicle, showing the rotor and propeller drive trains.

FIG. 13 is a perspective view of a single-engine powerplant for the compound helicopter of FIG. 12.

FIG. 14 is a side view of the single-engine powerplant shown in FIG. 13.

FIG. 15A is a section view of a wing for the compound helicopter of the present invention, having an umbrella flap and a slotted leading edge.

FIG. 15B is a section view of a wing for a compound helicopter of the present invention, having an umbrella flap and a slotted leading edge, with the flaps extended.

FIG. 16A is a section view of a wing for a compound helicopter of the present invention, having a conventional flap.

FIG. 16B is a section view of a wing for a compound helicopter of the present invention, having a conventional flap, with the flaps extended.

FIG. 17 is a block diagram of a control system for a compound helicopter of the present invention.

Similar reference characters denote corresponding features consistently throughout the attached drawings.

### DETAILED DESCRIPTION OF THE PREFERRED EMBODIMENTS

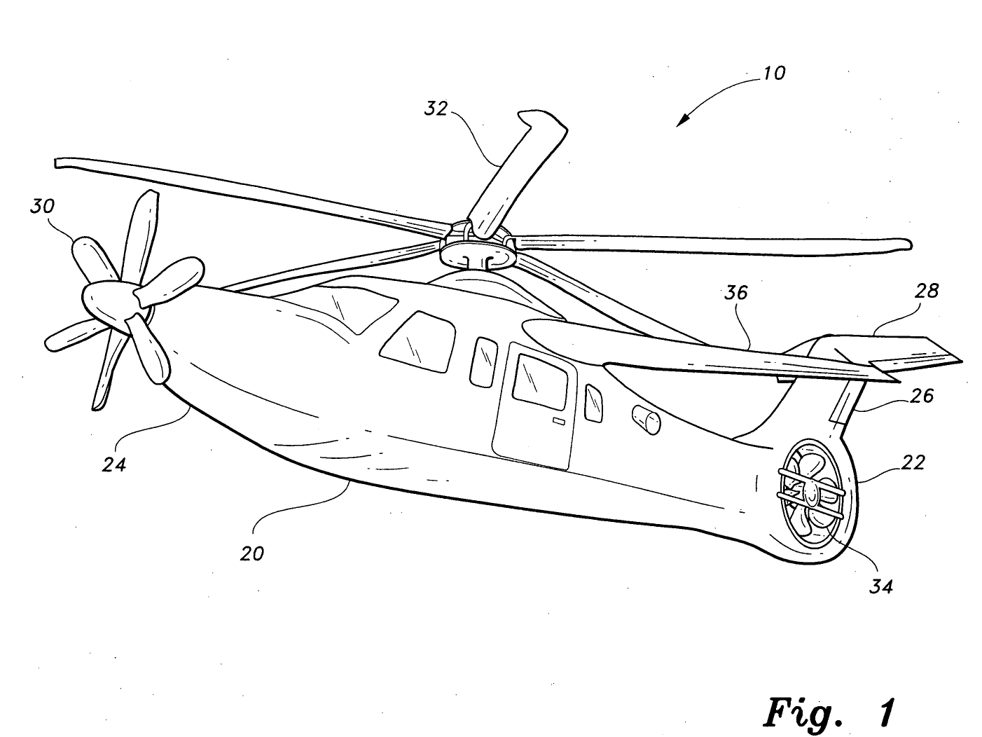

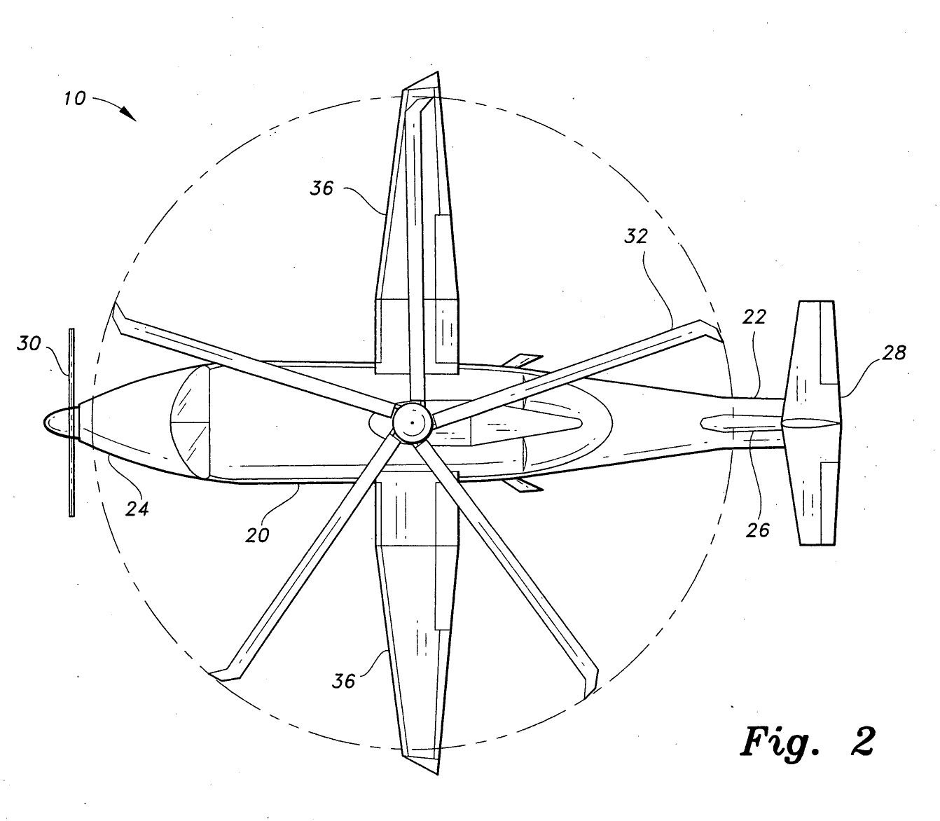

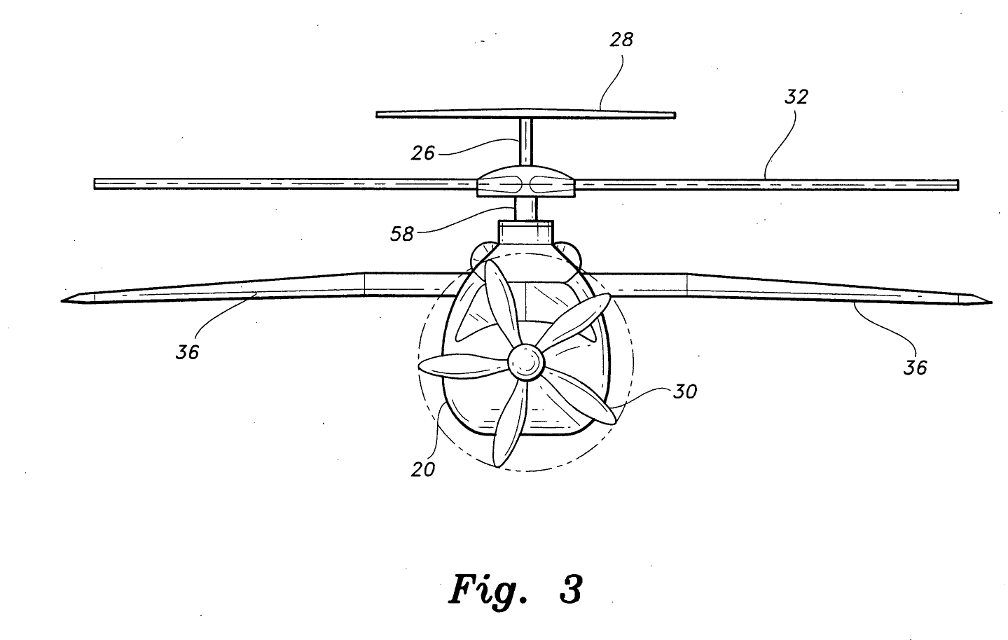

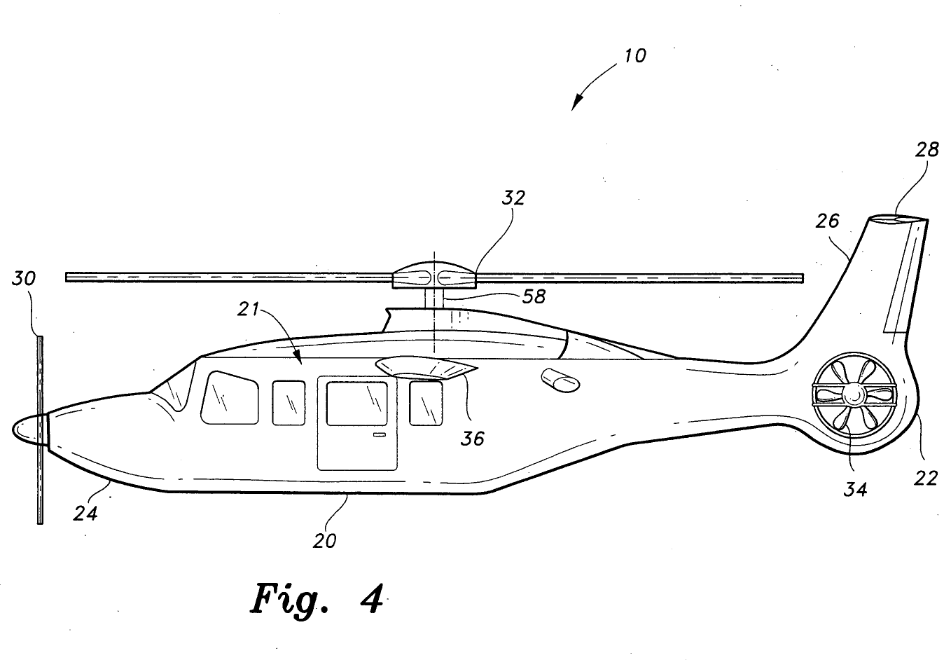

The present invention is a compound helicopter, designated generally as 10 in the drawings. Referring to FIGS. 1-4, the compound helicopter 10 is, generally, a conventional helicopter modified by the addition of a nose-mounted tractor propeller 30, to provide thrust for forward flight, and wings 36 to provide lift during forward flight. A conventional helicopter main rotor 32 provides for vertical flight, such as during takeoff and landing, and hovering operations. A tail fan 34 or tail rotor functions to counteract torque from the main rotor 32.

A fuselage 20 has a somewhat extended nose 24 so that the propeller 30, mounted on the nose 24, is located forward of the main rotor 32, eliminating the possibility of contact with the main rotor 32 at high rotor flap angles. This forward location of the propeller 30 places the propeller 30 in relatively undisturbed air, ahead of turbulence from the rotor downwash and turbulence caused by the airframe itself. A major advantage of the nose-mounted propeller 30 is that relatively low stresses are induced in the propeller 30 as it rotates in the relatively undisturbed air, allowing the propeller 30 to be operated more efficiently to produce greater thrust. Tail section 22 of the fuselage 20 carries, in addition to the tail fan 34 or tail rotor, the empennage of a conventional airplane, including a vertical fin 26 and a horizontal stabilizer 28 located aft of the main rotor 32. The fuselage 20 includes, in a passenger carrying embodiment, a cockpit or cabin area 21 suitable for pilot, crew, and passengers. An unmanned aerial vehicle (UAV) is also conceived wherein the cockpit or cabin area 21 is eliminated or made available for payloads.

Wings 36 are affixed to each side of the fuselage 20, and are optimized for high altitude cruising. The wings 36 are positioned, and droop slightly toward their tips, to maintain clearance from the main rotor 32 for at least a 30° rotor flap angle. The wings 36 have a relatively high aspect ratio for reduced induced drag during high speed cruise. The high aspect ratio wings 36 also, because they are relatively narrow, present a reduced flat plate area beneath the main rotor 32, decreasing vertical drag during vertical or hovering operations.

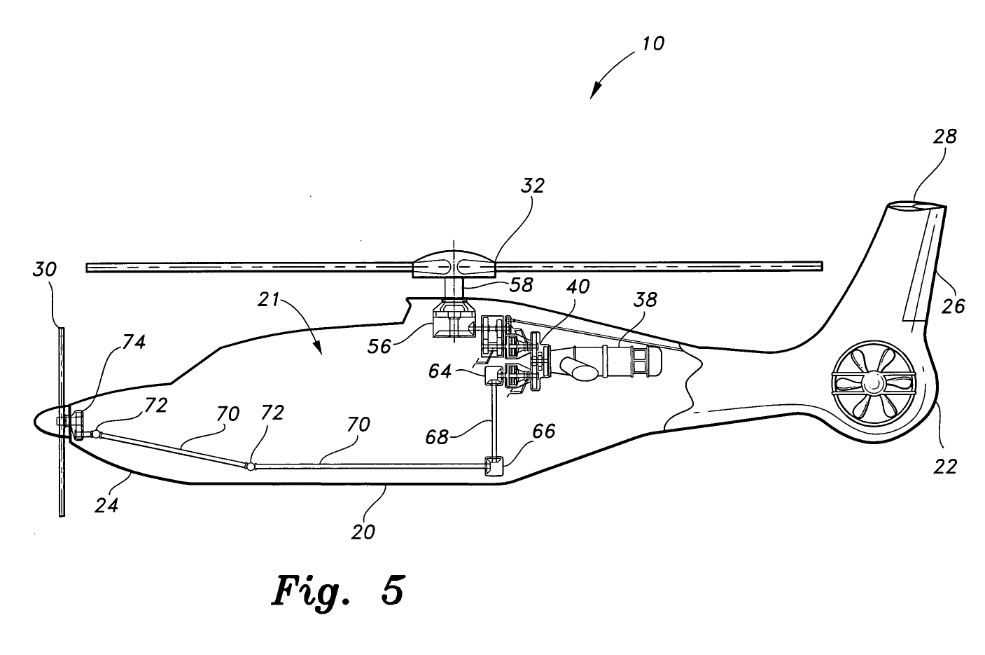

The compound helicopter is powered by a single powerplant that drives both the main rotor 32 and the propeller 30. The single powerplant may be of a single engine or a twin engine configuration. Turning now to FIG. 5, the compound helicopter is illustrated with a twin-engine powerplant. The powerplant comprises twin engines 38 of any suitable type, such as turboshaft engines, coupled by a combining gearbox 40. An advantage of this arrangement is that if one of the engines 38 fails, the other continues to provide power for both the main rotor 32 and the propeller 30. For weight and balance considerations, the powerplant is best located generally amidship, in an upper part of the fuselage 20 behind the cabin area.

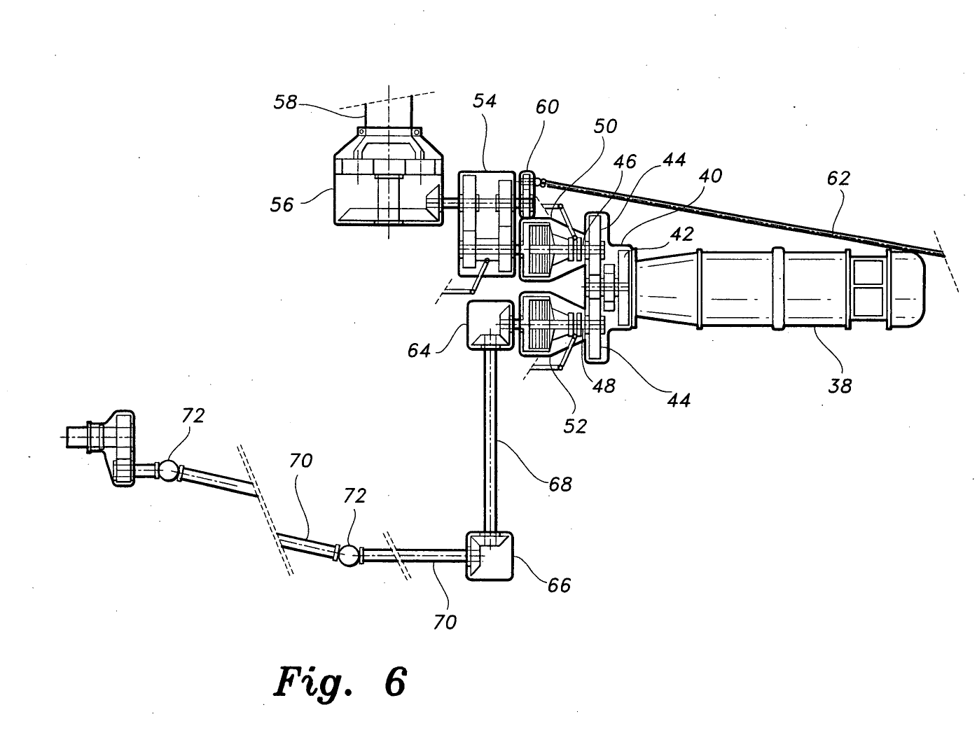

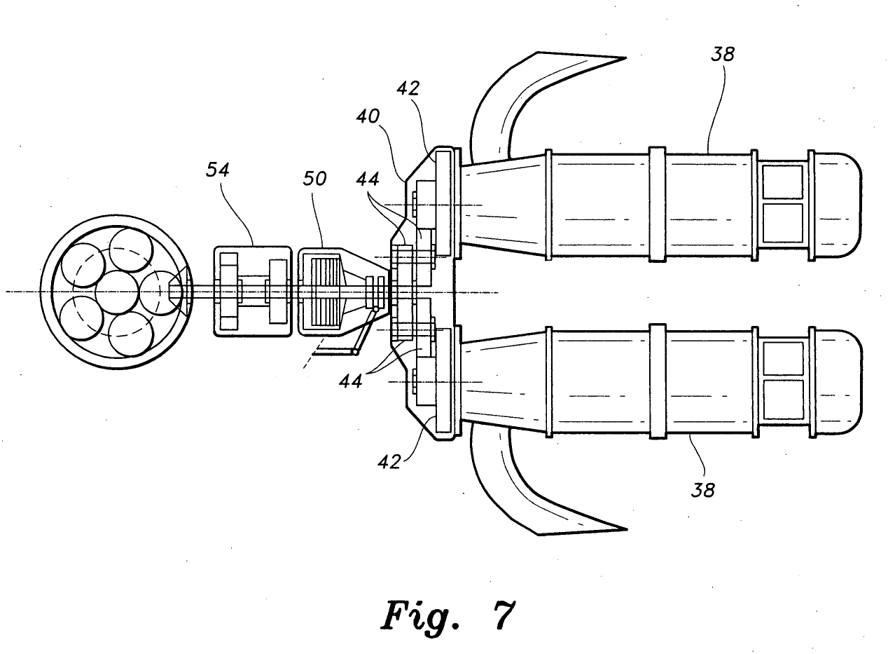

A twin-engine drive train arrangement is shown in greater detail in FIGS. 6 and 7. The combining gearbox 40 combines the output of the engines 38, using a freewheeling clutch 42 connected to each of the engines 38 to accommodate single engine operation in the event of an engine outage. Reduction gears 44 reduce the engine output speed to about 6,000 rpm. The combining gearbox 40 provides power output on an upper and a lower output shaft 46 and 48, respectively. The combining gearbox 40 also provides some accessory drive pads for supporting the power requirements for the accessory devices, such as the hydraulic pumps and electrical generators.

Two identical clutches 50 and 52 are connected directly at the combining gearbox 40 output shafts 46 and 48. The upper clutch 50 drives the main rotor 32, while the lower clutch 52 drives the nose-mounted propeller 30. With a separate clutch provided for the propeller 30 and the main rotor 32, either can be separately engaged with, or disengaged from, the powerplant. This allows the propeller 30 to be disengaged during takeoff and landing procedures, and during other situations in proximity to the ground, providing greater safety for personnel near the aircraft. During cruising operation, the main rotor 32 is disengaged from the powerplant and allowed to auto-rotate.

From the output of the upper clutch 50, power is transmitted to a multi-speed transmission 54. A gear selector allows selection of the transmission output at full speed, or at a reduced speed. The gear selector is operated from a gear selector control switch located in the cockpit or cabin area 21.

The transmission 54 drives a main rotor gearbox 56. The main rotor gearbox 56 includes reduction gearing to produce a suitable main rotor speed. This type of gearbox is common to most helicopters. A main rotor shaft 58 extending from the main rotor gearbox 56 drives the main rotor 32. Additionally, the transmission 54 provides a tail rotor output 60 that connects to a tail rotor shaft 62 to drive the tail fan 34.

From the output of the lower clutch 52, power is transmitted to an upper pair of bevel gears 64 that drives a vertical shaft 68. The vertical shaft 68 extends downward to near the bottom of the fuselage 20.

A lower pair of bevel gears 66 translates power from the vertical shaft to a propeller drive shaft 70 that extends forward to the nose 24 of the fuselage 20. Flexible universal couplings 72 join sections of the propeller drive shaft 70, accommodating bends in the propeller drive shaft 70 required to reach the nose 24 of the fuselage 20. A propeller gearbox 74 (shown in FIG. 5) is mounted in the nose 24 of the fuselage 20, and is driven by the propeller drive shaft 70. The propeller gearbox 74 is a single stage reduction gear that drives the propeller 30. The propeller gearbox 74 also provides a mounting pad for a propeller control unit, an over-speed governor and a high-pressure oil pump for operation of the propeller control unit, as well as gear lubrication.

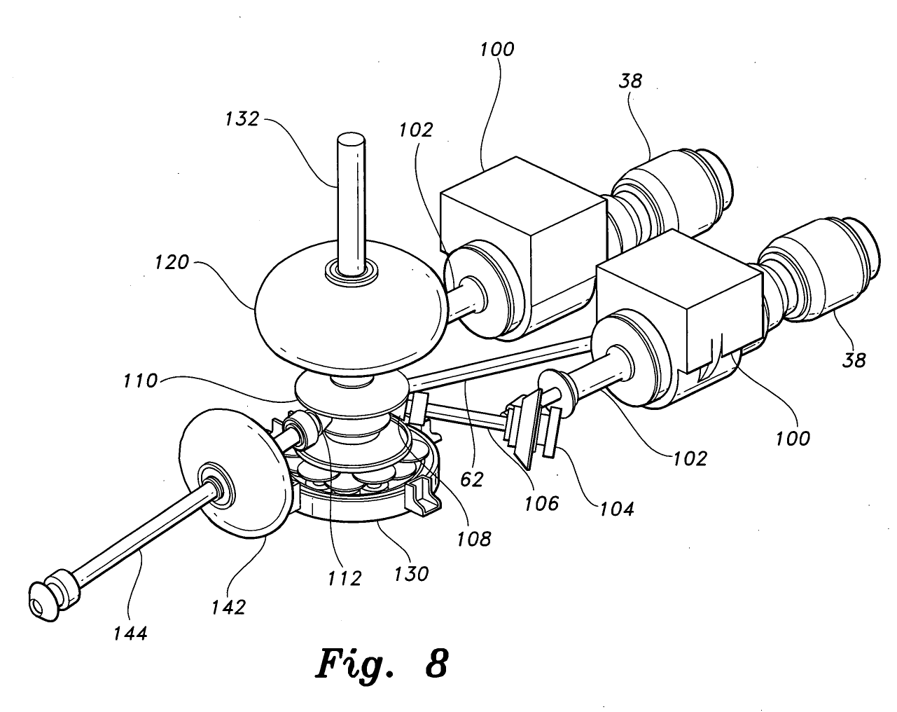

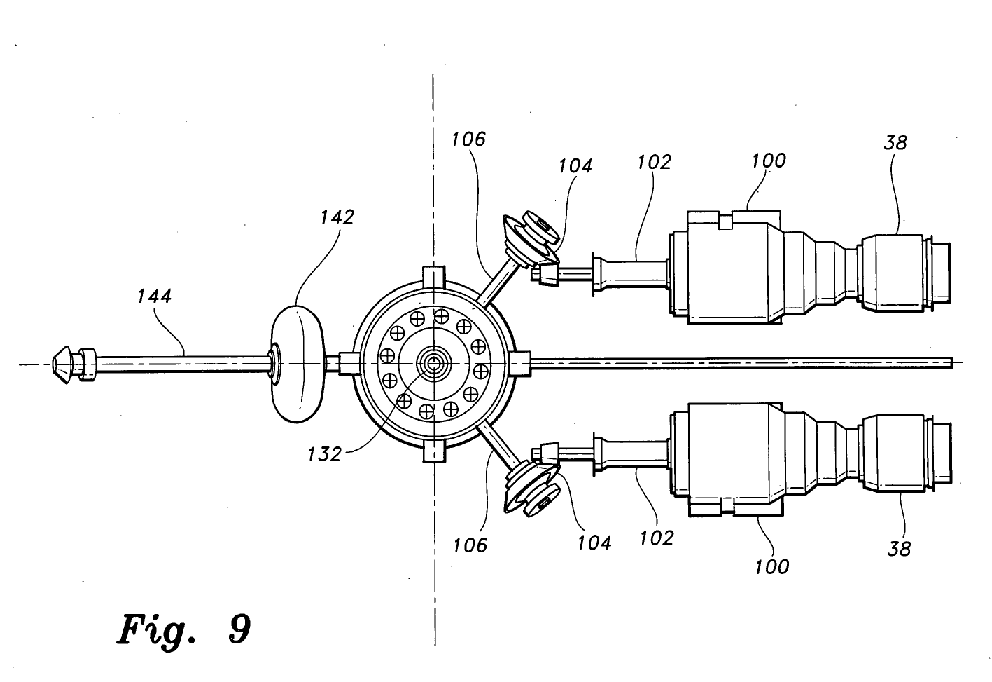

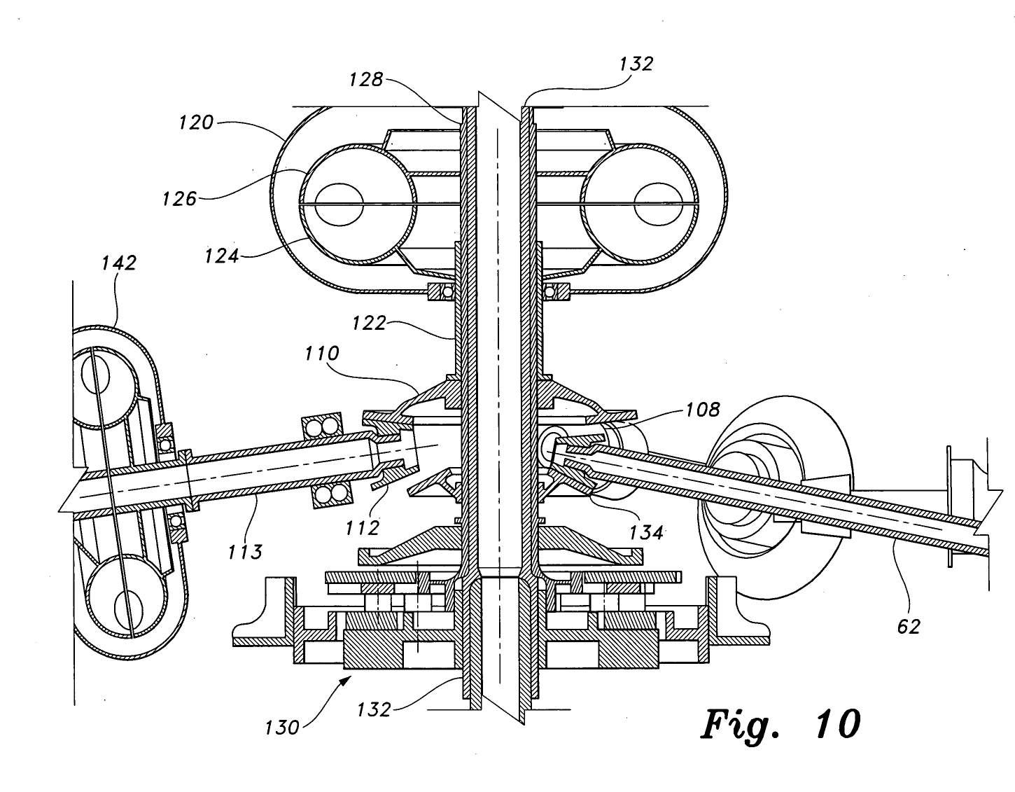

Turning now to FIGS. 8-10, a preferred twin-engine powerplant and transmission is illustrated. This embodiment features a transmission assembly in connection with a pair of turboshaft engines 38, the transmission assembly having a plurality of output shafts for driving the propeller 30, the main rotor 38, and the tail rotor, respectively. Each of the turboshaft engines 38 has a freewheeling clutch 100 connecting the engine 38 to a first drive shaft 102, which is, in turn, connected by a reducing bevel gear assembly 104 to a second drive shaft 106. The freewheeling clutch 100 allows for single engine operation in the event of an engine outage. The bevel gear assembly 104 provides for about a 3:1 reduction in shaft rpm between the first drive shaft 102 and the second drive shaft 106.

A main gearbox module is driven by the twin turboshaft engines 38. The main gearbox module comprises a multiple concentric shaft coupling a hydrodynamic coupling 120 and a planetary gearbox 130. An outer shaft 122 is driven by a main spiral bevel gear 110, which is driven by each of the engines 38 via second drive shafts 106. The outer shaft 122, in turn, drives a hydrodynamic coupling 120. The hydrodynamic coupling 120 comprises a radial impeller 124, driven by the outer shaft 122, and a radial turbine 126, coupled to an inner shaft 128, the inner shaft being located concentrically within the outer shaft 122. The hydrodynamic coupling 120 is a fluid coupling. Engine torque, applied by the second drive shaft 106 of each engine 38 to the outer shaft 122 by spiral bevel gear 100, is converted within the hydrodynamic coupling 120 by the impeller 124 into moving fluid energy. The fluid energy is transformed back into mechanical energy by the turbine 126, driving the inner shaft 128. Thus, hydraulic fluid within the hydrodynamic coupling 120 functions to transfer energy from the outer shaft 122 to the inner shaft 128. Emptying the hydraulic fluid from the hydrodynamic coupling 120 prevents the turbine 126 from rotating even as the impeller 124 rotates, thereby disengaging the inner shaft 128. The hydrodynamic coupling 120 preferably includes a mechanical clutch to engage and cause a positive no-slip coupling between the impeller 124 and the turbine 126, the mechanical clutch beginning to engage as the turbine 126 “catches up” with the impeller 124, reaching approximately eighty-eight percent of the impeller's speed.

The inner shaft 128 drives both the main rotor, through a planetary gear system 130, and the tail rotor. A bevel gear set 134 is driven by the inner shaft 128 to provide a power take off for the tail rotor shaft 62. The planetary gear system 130, driven by the inner shaft 128, provides a further reduction in rpm to drive the main rotor shaft 132. The main rotor shaft 132 is disposed concentrically within the inner shaft 128, and extends upward through the hydrodynamic coupling 120 to drive the main rotor. It can be recognized that the hydrodynamic coupling 120 provides a mechanism to engage and disengage both the main rotor and the tail rotor from the engine power.

A hydrodynamic coupling 142 is also employed in the propeller drivetrain, to allow the propeller 30 to be engaged and disengaged from the powerplant independently from the main rotor 32. A propeller drive takeoff shaft 113 has a bevel gear 112 engaged with the main spiral bevel gear 110. The propeller drive takeoff shaft 113 in turn drives an input to the hydrodynamic coupling 142. The hydrodynamic coupling 142 drives a first propeller drive shaft 144, that engages with the vertical shaft 68 to drive the remainder of the propeller drive train generally as shown in FIG. 6. Note that, in the case of a UAV, it is unnecessary to employ flexible couplings 72 to route the propeller shaft 70 clear of a passenger cabin or cockpit area 21. Instead, the propeller shaft 70 may be a single, straight shaft length.

While a twin engine powerplant generally as described is a preferred power source for a manned, passenger-carrying embodiment of the compound helicopter, unmanned and remotely piloted embodiments of the compound helicopter are conceived that may benefit from a smaller overall size and may be best suited to a single engine power plant configuration.

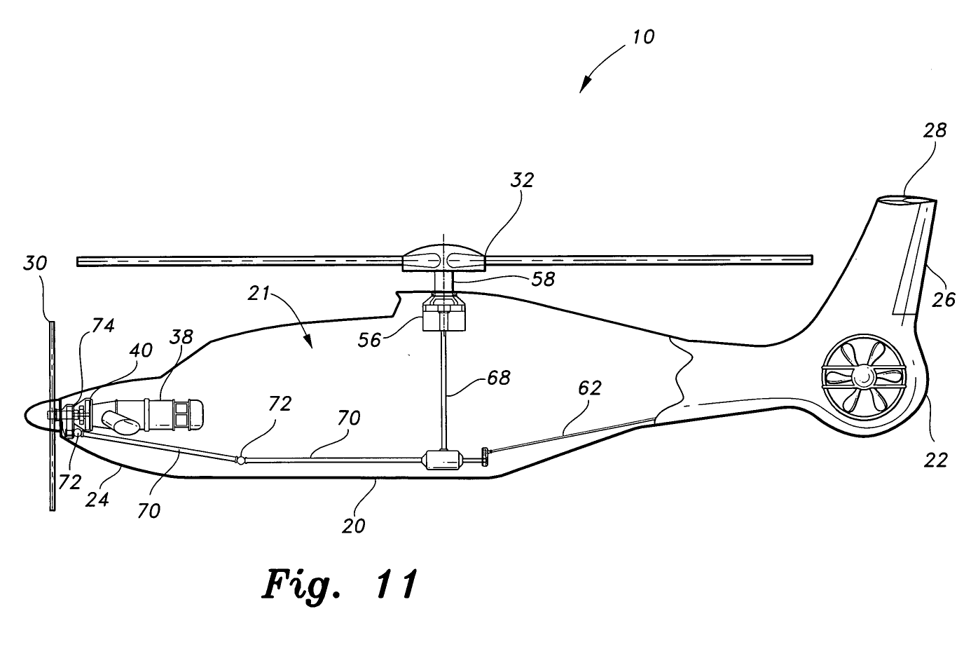

Referring to FIG. 11, an alternate configuration of the compound helicopter is shown with the powerplant located in the nose 24 of the fuselage 20. This arrangement, particularly using a single engine powerplant, may be suitable for some applications but presents weight and balance challenges. It is also possible, in a further embodiment not illustrated, to locate a first engine in the nose to drive the propeller 30 and a second engine amidship to drive the main rotor 32.

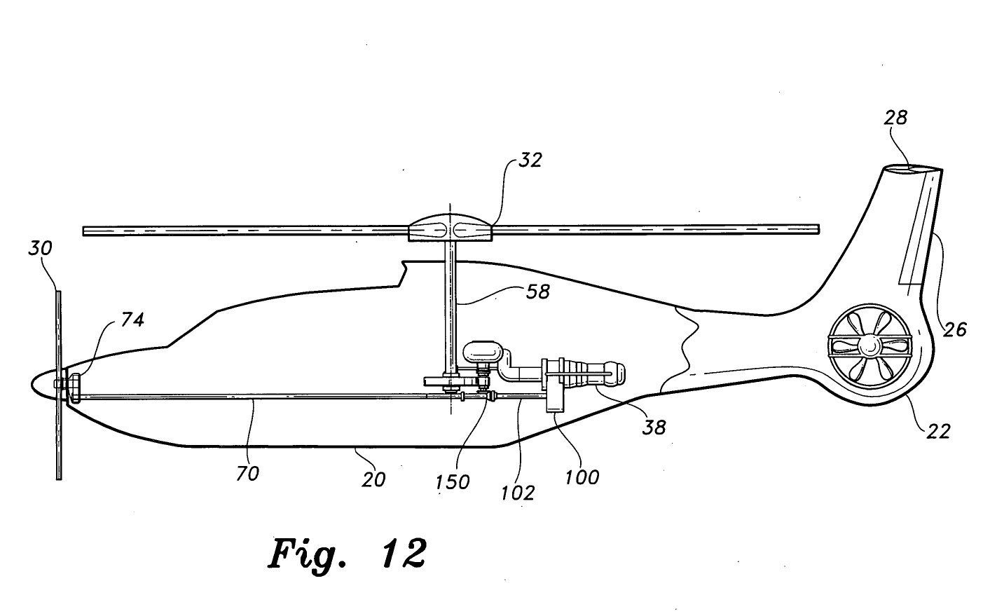

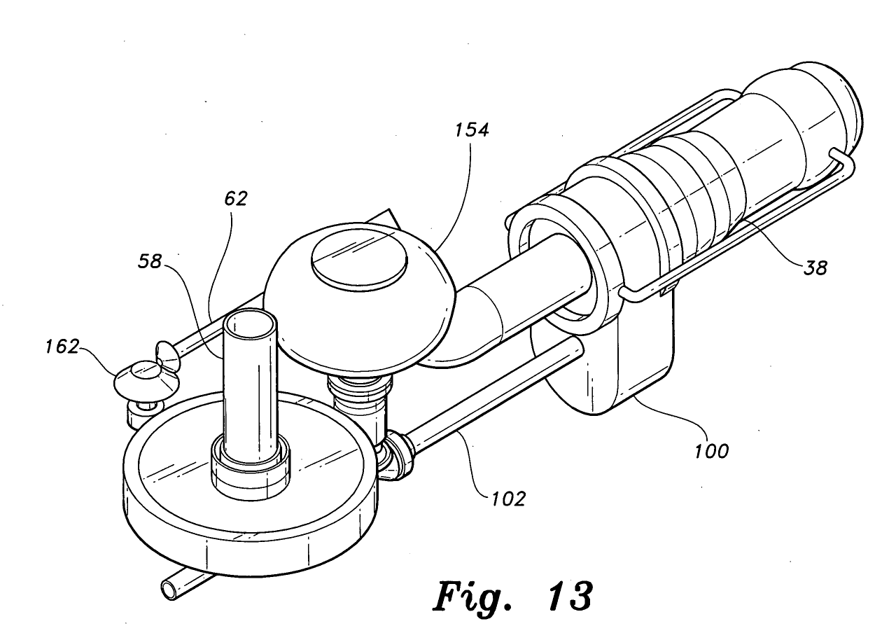

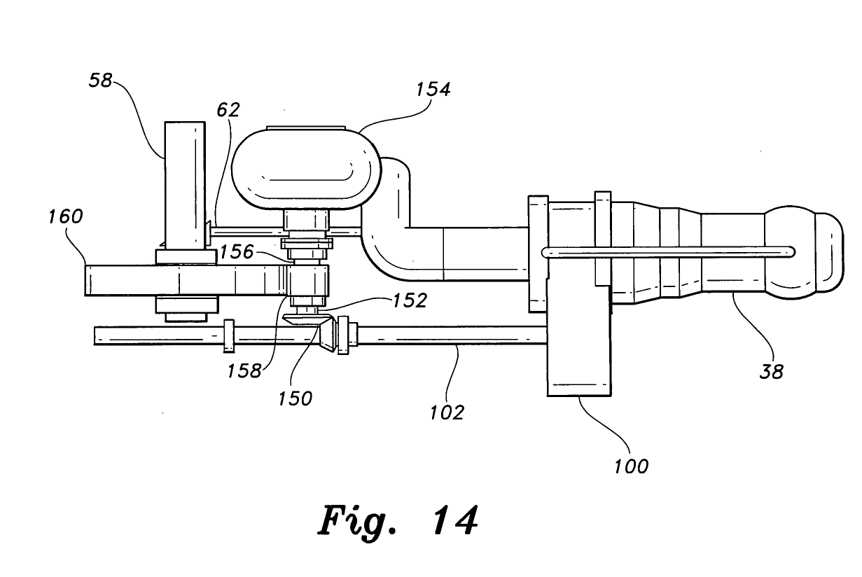

Turning now to FIGS. 12-14, a single engine configuration of the compound helicopter is illustrated that is well suited for use as an unmanned aerial vehicle (UAV).

The powerplant is located generally amidship, just behind the main rotor shaft 58, comprising a single turbine engine 38 and a transmission assembly having a plurality of output shafts for driving the propeller 30, the main rotor 38, and the tail rotor, respectively. The single engine 38 turns an output shaft 102, connected to a bevel gear set 150. A first output of the bevel gear set 150 is a vertical shaft connected to a hydrodynamic coupling 154. A second output of the bevel gear set 150 connects to the propeller shaft 70.

The hydrodynamic coupling 154 has dual concentric shafts, consisting of an input shaft 152 and an output shaft 156. The input shaft 152 is the inner shaft of the dual concentric shaft arrangement, the output shaft 156 being the outer shaft. The input shaft 152 is driven by the bevel gear set 150. Within the hydrodynamic coupling 154, impeller rotors connected to the input shaft 152 drive turbine blades connected to the output shaft 156 through a hydraulic fluid medium. Emptying the hydraulic fluid from the hydrodynamic coupling 154 prevents the turbine blades from rotating even as the impeller blades rotate, thereby disengaging the input shaft 152 from the output shaft 156. A hydraulic oil pump is provided to pump oil into and out of the hydrodynamic coupling 154. Additionally, the hydrodynamic coupling 154 includes a one-way clutch that allows the outer shaft 156 to turn faster than the input shaft 152, thereby allowing the main rotor to autorotate in the event the engine 38 is shut down during flight. Gear 158, disposed on the output shaft 156, drives gear 160 disposed on the main rotor shaft 58. Gear 160 also drives the tail rotor shaft 62 by way of bevel gear set 162.

A propeller gearbox 74 (shown in FIG. 12) is mounted in the nose 24 of the fuselage 20, and is driven by the propeller drive shaft 70. The propeller gearbox 74 is a single stage reduction gear that drives the propeller 30. The propeller gearbox 74 also provides a mounting pad for a propeller control unit, an over-speed governor and a high-pressure oil pump for operation of the propeller control unit, as well as gear lubrication.

The wings 36 will provide about 70% of the required lift for the compound helicopter 10 during cruising flight, also referred to as the airplane flight mode. The main rotor 32 provides the remaining lift while auto-gyrating in cruising flight. The cantilevered high wings are installed above the cabin on each side of the fuselage. The wings 32 have a relatively high aspect ratio, and are optimized for cruising flight. Desirable aerodynamic features of the wings 32 include low drag, high coefficient of lift, gentle trailing edge stall characteristics, and a sufficient maximum thickness and favorable chord-wise thickness distribution for structural efficiency and low weight. An aerofoil section, such as the NACA 653-218 aerofoil, provides these characteristics.

The relatively narrow, high aspect ratio wings 32 present a reduced flat plate area, decreasing vertical drag during vertical or hovering operations. Wing flaps may be deployed to further reduce vertical drag.

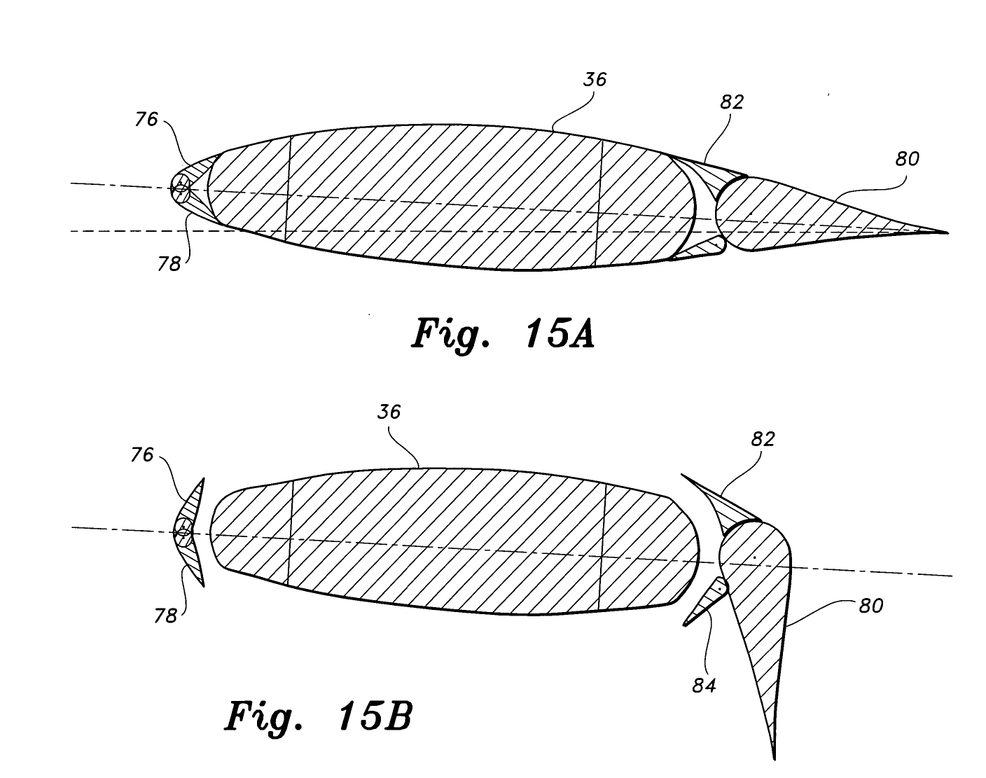

An “umbrella” flap design in conjunction with a slotted leading edge, shown in FIGS. 15A and 15B, provides the maximum reduction in vertical drag. Upper and lower leading edge slats 76 and 78 can be extended to create a leading edge slot, or retracted to form a smooth and continuous leading edge profile. A flap 80 is pivotally mounted at the trailing edge of the wing, with upper and lower trailing edge slats 82 and 84 providing a smooth trailing edge surface while the flap 80 is retracted. The flap width is about 30° of the wing chord. When the flap 80 is extended, pivoted downward up to 80°, the trailing edge slats 82 and 84 extend to provide a trailing edge slot in front of the flap 80. With the flap 80 and slats 76, 78, 82, and 84 fully extended, vertical drag is reduced 70-75% as compared to a bare wing. However, it has a penalty in its complexity of the mechanism to move the flaps 80 and slats 76, 78, 82, and 84.

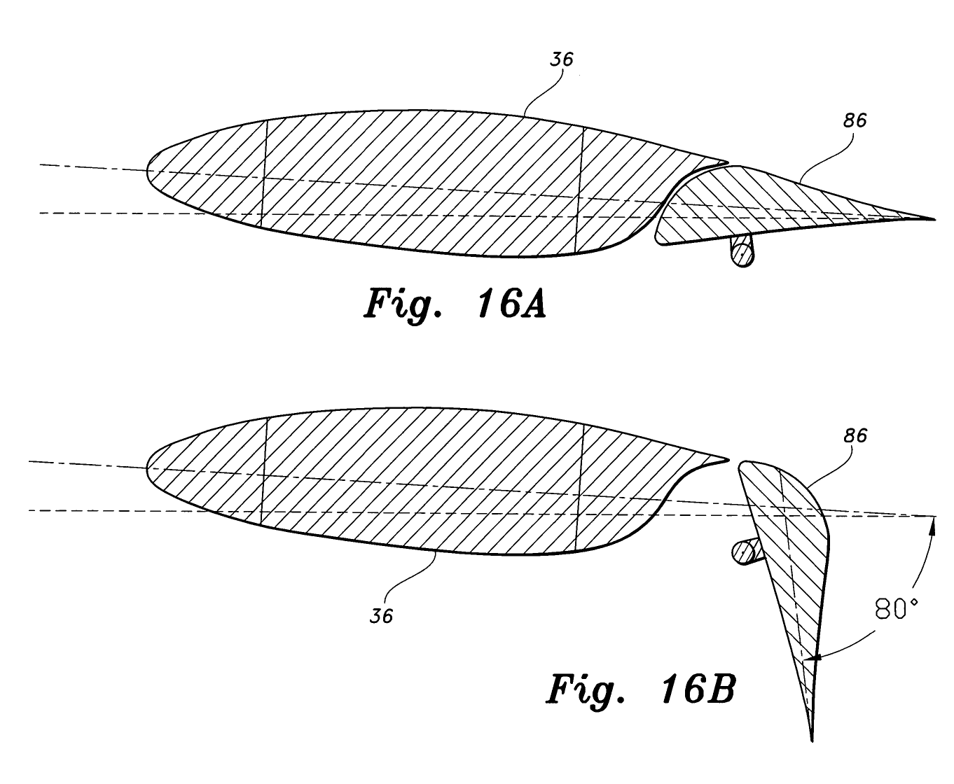

A simpler flap configuration is a conventional single slotted flap 86 shown in FIGS. 16A and 16B. The single slotted flap 86, about 350 of the wing chord, can be deflected to 80°, providing a 40-50% reduction in vertical drag.

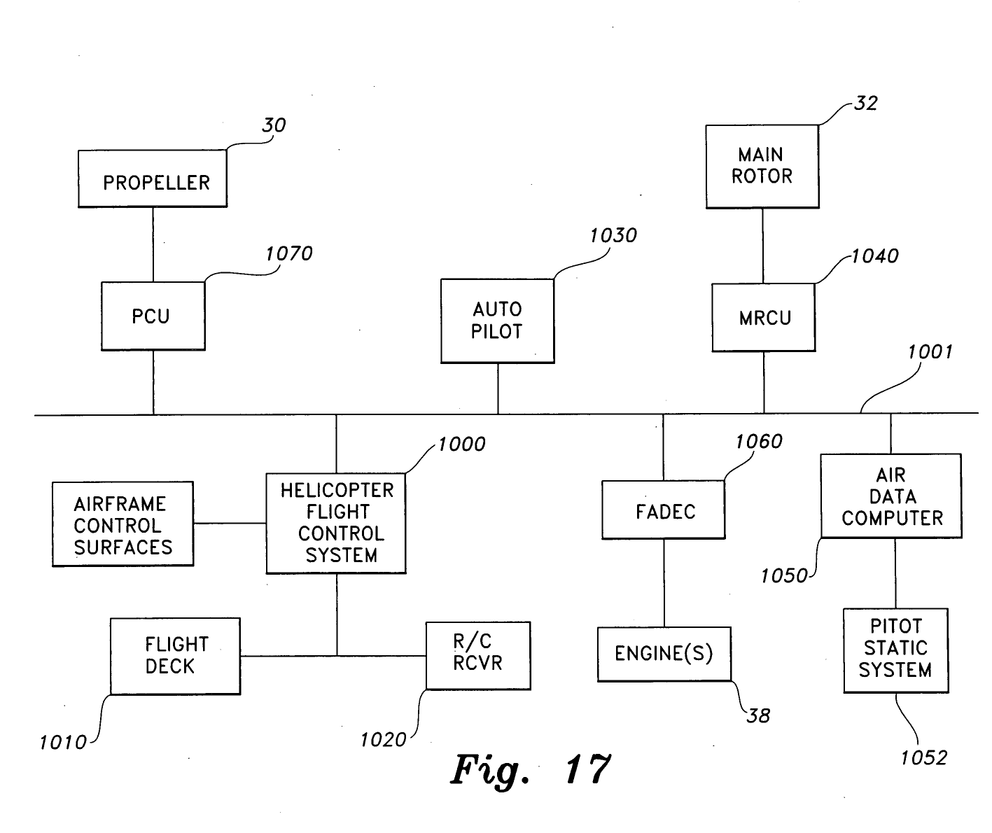

The use of lightweight materials, composites, fly-by wire controls, advanced digital display systems, digital navigation, communication and flight control systems, coupled with highly advanced composite propeller design, provides a breakthrough in compound helicopter design performance and technology. Turning to FIG. 17, a control system provides for engine control, synchronization of the propeller 30 and main rotor 32, and, in the case of unmanned or UAV embodiments, operation of all flight control systems by remote control. Elements of the control system communicate with one another over a common communication bus 1001, or over independent communication links where appropriate.

Referring to FIG. 17, a helicopter flight control system (HFCS) 1000 includes control elements for cyclic and collective inputs to the main rotor 32, yaw inputs to the tail fan 34, engine 38 power/speed, as well as control surfaces of the wings 36 and vertical stabilizer 26. The HFCS 1000 is driven by inputs from flight deck controls 1010 (or, in the case of the unmanned aerial vehicle, a remote control receiver 1020) and an autopilot 1030. The autopilot 1030 provides at least three axes of control. Fourth and fifth axes are rotor collective and engine power control, which are primarily relevant for missions requiring automation in the low speed regime. An air data computer 1050 gathers information from a pitot static system 1052, along with temperature information, and provides inputs to the autopilot 1030.

A full authority digital engine control (FADEC) module 1060 controls the engines 38 based on inputs from the pilot, the HFCS 100, and other control systems. The FADEC 1060 works in conjunction with a propeller control unit (PCU) 1070 and a main rotor control unit (MRCU) 1040 to optimize engine power settings, propeller pitch, and main rotor collective and cyclic settings. The FADEC 1060, MRCU 1040, and PCU 1070 cooperate to optimize control of the compound helicopter 10 through a helicopter flight mode wherein the main rotor 32 is the primary source of lift, an airplane flight mode wherein the wings 36 are the primary source of lift, and transition between helicopter and airplane flight modes. The FADEC 1060, MRCU 1040, and PCU 1070 work together to manage power sharing between the main rotor 32 and the propeller 30.

During operations in the helicopter flight mode, power is directed primarily to the main rotor 32. During operations in the airplane flight mode, power is directed primarily to the propeller 30. The main rotor 32 is controlled by the MRCU 1040 to achieve minimum drag during the airplane flight mode as the main rotor 32 autorotates due to the forward movement of the compound helicopter 10.

During the transition between helicopter flight mode and airplane flight mode, the FADEC 1060 and MRCU 1040 function to facilitate the transfer of lift between the main rotor 32 and the wings 36. The MRCU 1040 varies the speed of the main rotor 32 by varying the collective pitch of the main rotor 32. As main rotor speed and engine speeds are synchronized, such that the rotations of the hydrodynamic coupling's 120 outer shaft 122 and inner shaft 128 are approximately matched, the MRCU 1040 commands the hydrodynamic coupling's 120 mechanical clutch to engage, in transition from airplane mode to helicopter mode, or disengage in transition from helicopter mode to airplane mode.

With its inherent ability to auto-rotate as a conventional helicopter or glide as an airplane, the compound helicopter 10 offers a high degree of flight safety and crash survivability compared to other non-conventional helicopter technologies, such as tilt rotors. The simple nose-mounted propeller configuration makes the compound helicopter 10 maintenance- and pilot-friendly. The configuration also provides outstanding maneuverability and speed.

It is to be understood that the present invention is not limited to the embodiments described above, but encompasses any and all embodiments within the scope of the following claims.

1. A compound helicopter, comprising:
a fuselage having a nose and a tail;
a wing structure mounted on said fuselage;
a main helicopter rotor operably disposed on top of said fuselage, the main helicopter rotor having a plurality of rotor blades, the rotor blades defining a rotor disk;
a propeller operably disposed on the nose of said fuselage ahead of said rotor disk;
a powerplant disposed in said fuselage;
a propeller drive train connected between said powerplant and said propeller in order to drive said propeller; and
a main rotor drive train connected between said powerplant and said main rotor to drive said main rotor.

2. (canceled)

3. The compound helicopter according to claim 1, wherein said wing structure has a high aspect ratio.

4. The compound helicopter according to claim 1, wherein said wing structure comprises a pair of wings extending from either side of said fuselage, each of said pair of wings having a leading edge and a trailing edge.

5. The compound helicopter according to claim 4, wherein each of said pair of wings comprises at least one wing flap pivotally disposed on the trailing edge.

6. The compound helicopter according to claim 5, wherein said at least one wing flap comprises a slotted flap.

7. The compound helicopter according to claim 5, wherein said at least one wing flap comprises an umbrella flap having a flap member, an upper trailing edge slat, and a lower trailing edge slat.

8. The compound helicopter according to claim 4, wherein each of said pair of wings comprises a plurality of leading edge slats pivotally disposed on said leading edge.

9. The compound helicopter according to claim 1, wherein said propeller drive train comprises a clutch selectively engaging said propeller to, and disengaging said propeller from, said powerplant.

10. The compound helicopter according to claim 1, wherein said main rotor drive train comprises a clutch selectively engaging said main rotor to, and disengaging said main rotor from, said powerplant.

11. The compound helicopter according to claim 1, wherein said powerplant comprises:
at least one engine; and
a transmission coupled to said at least one engine, the transmission having a plurality of output shafts.

12. The compound helicopter according to claim 11, wherein said propeller drive train is connected to one of said output shafts.

13. The compound helicopter according to claim 12, wherein said transmission comprises means for selectively engaging and disengaging said propeller drive train to and from said one of said output shafts.

14. The compound helicopter according to claim 11, wherein said main rotor drive train is connected to one of said output shafts.

15. The compound helicopter according to claim 14, wherein said transmission comprises means for selectively engaging and disengaging said main rotor drive train to and from said one of said output shafts.

16. The compound helicopter according to claim 11, further comprising an engine control system operably connected to said at least one engine.

17. The compound helicopter according to claim 16, further comprising a main rotor control unit operably connected to said main rotor and in communication with said engine control system.

18. The compound helicopter according to claim 16, further comprising a propeller control unit operably connected to said propeller and in communication with said engine control system.

19. The compound helicopter according to claim 11, further comprising:
an engine control system operably connected to said at least one engine;
a propeller control unit operably connected to said propeller and in communication with said engine control system; and
a main rotor control unit operably connected to said main rotor and in communication with said engine control system.

20. The compound helicopter according to claim 16, wherein said engine control system is a full authority digital engine controller.
